(19) United States
(12) Patent Application Publication
(10) Pub. No.: US 2009/0248249 A1
(43) Pub. Date: Oct. 1, 2009

(54) METHOD FOR DETERMINING CONTROLLED VARIABLE OF COORDINATE CONTROL ON SPLIT ROAD SURFACE USING DECELERATION OF VEHICLE

(75) Inventor: In Hye Park, Seoul (KR)

Correspondence Address: SEED INTELLECTUAL PROPERTY LAW GROUP PLLC, 701 FIFTH AVE, SUITE 5400, SEATTLE, WA, 98104, US

(73) Assignee: MANDO CORPORATION, Pyeongtaek-si (KR)

(21) Appl. No.: 12/393,703

(22) Filed: Feb. 26, 2009

(30) Foreign Application Priority Data
Mar. 28, 2008 (KR) 10-2008-0029068

(51) Int. Cl. B60W 30/02

(52) U.S. Cl. 701/42; 701/41

(57) ABSTRACT

Disclosed herein is a method of determining a controlled variable of coordinate control on a split road surface using deceleration of a vehicle. The method includes calculating deceleration of the vehicle by differentiating a reference velocity (Vref) calculated by an electronic stability control system, calculating an override angle of an active front-wheel steering system by multiplying the deceleration of the vehicle by a control gain, determining a control direction of the vehicle, and obtaining a controlled variable for a steering angle by multiplying the calculated override angle of the active front-wheel steering system by the determined control direction of the vehicle. The method enables the vehicle to maintain a straight behavior without driver's steering intervention when the driver brakes on the split road surface

### BACKGROUND

1. Technical Field

The present disclosure relates to a method of determining a controlled variable of coordinate control on a split road surface using deceleration of a vehicle, and more particularly, to a method of determining a controlled variable of coordinate control on a split road surface using deceleration of a vehicle, which permits control of the vehicle based on deceleration information of the vehicle for stability

2. Description of the Related Art

When braking on a road surface with dissymmetry friction, on which an icy sheet or the like is formed corresponding to only one of left and right wheels, a vehicle tends to move toward a side having a high road friction since the left and right wheels exhibit different braking force according to the road friction. To prevent the vehicle from suffering such a movement toward a side having a high road friction, a conventional coordinate control between an active front-wheel steering system and an electronic stability control system is based on a delta yaw rate that is a difference between a yaw rate obtained by sensing the behavior of the vehicle through a sensor and a yaw rate calculated by the electronic stability control system, so that the vehicle can undergo a great yaw motion, thereby enlarging a difference between the left and right yaw motions.

Further, a controlled variable equilibrium may be lost according to how a driver steps on the brake. For example, when the brake is actuated quickly, the delta yaw rate becomes large due to a large instantaneous break force of the vehicle. In this case, a controlled variable for a steering angle of the vehicle is properly generated, so that the vehicle can move straight. On the other hand, when the brake is actuated slowly, the delta yaw rate becomes relatively small due to a relatively small break force of the vehicle. In this case, the controlled variable for the steering angle of the vehicle is relatively small, thereby causing the vehicle to move toward the road surface having the high friction.

### BRIEF SUMMARY

The present disclosure is directed to solve the problem of the conventional technique as described above, and one embodiment includes maintaining a straight behavior of a vehicle without driver's steering intervention when braking on a split road surface.

In accordance with one aspect, a method of determining a controlled variable of coordinate control on a split road surface using deceleration of a vehicle is provided. The method comprises: calculating deceleration of the vehicle by differentiating a reference velocity Vref calculated by an electronic stability control system; calculating an override angle of an active front-wheel steering system by multiplying the deceleration of the vehicle by a control gain; determining a control direction of the vehicle; and obtaining a controlled variable for a steering angle by multiplying the calculated override angle of the active front-wheel steering system by the determined control direction of the vehicle.

### BRIEF DESCRIPTION OF THE DRAWING

FIG. 1 is a flowchart of a method for determining a controlled variable of coordinate control on a split road surface using deceleration of a vehicle according to one embodiment.

### DETAILED DESCRIPTION

Hereinafter, embodiments of the present disclosure will be described in detail with reference to the accompanying drawing.

These embodiments control behavior of a vehicle using characteristics of an active front-wheel steering system where there is a difference between a steering angle of a driver and an actual steering angle, when performing coordinate control between the active front-wheel steering system and an electronic stability control system based on a delta yaw rate that is a difference between a yaw rate obtained by sensing the behavior of the vehicle through a sensor and a yaw rate calculated by the electronic stability control system.

When braking on a road surface having dissymmetry friction under actual coordinate control between the active front-wheel steering system and the electronic stability control system, the behavior of the vehicle can be controlled with the electronic stability control system since a wheel angle of the vehicle is steered without driver's steering intervention.

A conventional coordinate control between the active front-wheel steering system and the electronic stability control system uses only the delta yaw rate when braking without steering on the road surface having the dissymmetry friction, whereas the present disclosure is directed to a method that additionally uses deceleration information of the vehicle for stability.

If only the delta yaw rate is used as in the conventional coordinate control, a controlled variable for a steering angle is determined according to a yaw motion depending on braking pressure of the vehicle. Accordingly, when a relatively small braking pressure applies braking force, the controlled variable for the steering angle decreases so that it can be difficult to achieve straight braking on the road surface having the dissymmetry friction. To overcome the difficulty of the straight braking, one embodiment of the present disclosure draws out the deceleration of the vehicle and changes the controlled variable for the steering angle based on the deceleration, thereby keeping the vehicle straight without driver's steering intervention when braking on the road surface having the dissymmetry friction.

For this purpose, in one embodiment, information about the deceleration of the vehicle and information about motion behavior of the vehicle according to the deceleration can be gathered.

It is possible to calculate deceleration by differentiating a reference velocity Vref, which is calculated by the electronic stability control system. A control gain variable of the active front-wheel steering system is calculated and adjusted in proportion to the calculated deceleration, in which a limit value of the controlled variable is varied according to whether the driver intends to steer.

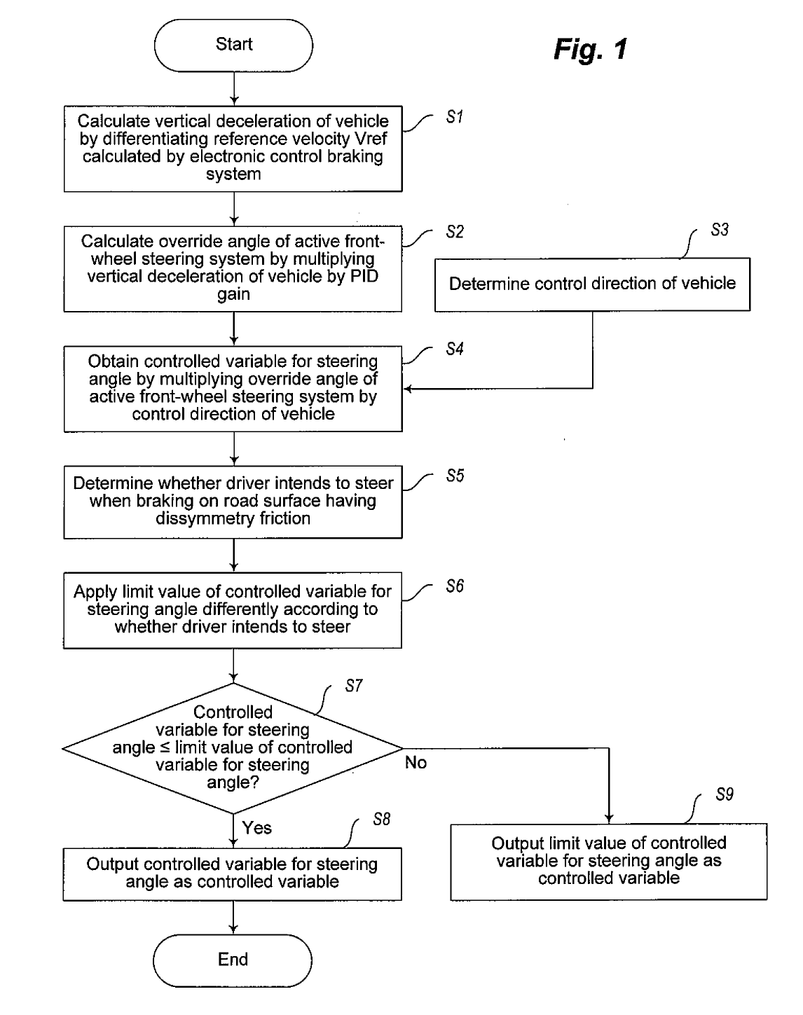

Such a method of determining the controlled variable of the coordinate control on the split road surface using the deceleration of the vehicle according to one embodiment is shown in a flowchart of FIG. 1.

First, a deceleration of a vehicle is calculated by differentiating a reference velocity Vref calculated by an electronic stability control system in step S1.

In step S2, the deceleration of the vehicle is multiplied by a control gain (for example, a proportional-integral derivative (PID) control gain) to calculate an override angle of the active front-wheel steering system. Here, the override angle of the active front-wheel steering system includes a signal for requesting the active front-wheel steering system to provide a voluntary steering angle.

In step S3, a control direction of the vehicle is set to “1” in the case of a “+” direction and “−1” in the case of a “−” direction. Here, the control direction of the vehicle is determined based on braking pressure of each of the left and right wheels.

In step S4, the override angle of the active front-wheel steering system calculated in step S2 is multiplied by the control direction of the vehicle determined in step S3, thereby obtaining the controlled variable for the steering angle.

In step S5, it is determined whether a driver intends to steer when braking on the road surface having the dissymmetry friction. In this regard, determination as to whether the driver intends to steer is performed based on a driver's steering angle and a driver's steering angular velocity. For example, if a condition that the driver's steering angle is larger than a predetermined value and a condition that the driver's steering angular velocity is larger than another predetermined value are satisfied at the same time, it is determined that the driver intends to steer. On the other hand, if any one of these two conditions is not satisfied, it is determined that the driver has no intention to steer. The predetermined values for comparing the driver's steering angle and the driver's steering angular velocity will be varied depending on designs of vehicles, and thus exemplary descriptions thereof will be omitted.

In step S6, a limit value of the controlled variable for the steering angle is differently applied according to whether a driver intends to steer. In other words, as a result of the step S5, the case that the driver intends to steer and the case that the driver has no intention to steer will have different limit values of the controlled variable for the steering angle.

In step S7, the controlled variable for the steering angle obtained in step S4 is compared with the limit value of the controlled variable for the steering angle applied in step S6.

With the result that the controlled variable for the steering angle is compared with the limit value of the controlled variable for the steering angle, if the controlled variable for the steering angle obtained in step S4 is less than or equal to the limit value of the controlled variable for the steering angle applied in step S6, the method includes outputting the controlled variable for the steering angle is as a controlled variable in step S8.

On the other hand, with the result that the controlled variable for the steering angle is compared with the limit value of the controlled variable for the steering angle, if the controlled variable for the steering angle obtained in step S4 is more than the limit value of the controlled variable for the steering angle applied in step S6, the method includes outputting the limit value of the controlled variable for the steering angle is as a controlled variable in step S9.

As described above, according to one embodiment, the method determines a controlled variable of coordinate control on a split road surface using deceleration of a vehicle, so that the vehicle can maintain a straight behavior on the split road surface without driver's steering intervention when the driver brakes on the split road surface.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method of determining a controlled variable of coordinate control on a split road surface using deceleration of a vehicle, the method comprising:
calculating a deceleration of the vehicle by differentiating a reference velocity (Vref) calculated by an electronic stability control system;
calculating an override angle of an active front-wheel steering system by multiplying the deceleration of the vehicle by a control gain;
determining a control direction of the vehicle; and
obtaining a controlled variable for a steering angle by multiplying the calculated override angle of the active front-wheel steering system by the determined control direction of the vehicle.

2. The method according to claim 1, further comprising:
determining whether a driver intends to steer when braking on the road surface having dissymmetry friction;
applying a limit value of the controlled variable for the steering angle differently according to whether the driver intends to steer;
comparing the controlled variable for the steering angle with the limit value of the controlled variable for the steering angle;
outputting the controlled variable for the steering angle as a controlled variable if the controlled variable for the steering angle is less than or equal to the limit value of the controlled variable for the steering angle; and
outputting the limit value of the controlled variable for the steering angle as a controlled variable if the controlled variable for the steering angle is more than the limit value of the controlled variable for the steering angle.

3. The method according to claim 1 wherein the control direction of the vehicle is set to 1 with respect to a “+” direction and −1 with respect to a “−” direction based on braking pressure of each of the left and right wheels.

4. The method according to claim 2 wherein the determining whether a driver intends to steer is performed based on a driver's steering angle and a driver's steering angular velocity.
